(19) United States
(12) Patent Application Publication
(10) Pub. No.: US 2012/0104016 A1
(43) Pub. Date: May 3, 2012

(54) WIPING MATERIAL SYSTEM AND METHODS

(75) Inventors: Giovanni Benedetti, Wishaw (GB); Malin Andersson, Hovas (SE); Björn Larsson, Billdal (SE)

(73) Assignee: SCA Hygiene Products AB, Göteborg (SE)

(21) Appl. No.: 13/379,716

(22) PCT Filed: Jun. 11, 2010
(86) PCT No.: PCT/SE10/50659

§ 371 Date: Dec. 21, 2011

(30) Foreign Application Priority Data
Jun. 30, 2009 (SE) 0950508-2

(51) Int. Cl. A47K 10/32; B23P 11/00; A47K 10/24

(52) U.S. Cl. 221/92; 29/428

(57) ABSTRACT

A wiping material system including a plurality of dispensers (10) of different shapes and/or sizes, the dispensers each having at least a first (12) and a second component (14) which are visible to a user. To assist in recognizing the fact that the dispensers of different sizes are all dispensers, the first component (12) is of a colour distinct from the second component (14) and the colour of the first component and the colour of the second component are identical for all dispensers (10) of the plurality of dispensers.

### CROSS-REFERENCE TO RELATED APPLICATIONS

This application is a National Phase Entry of International PCT patent application No. PCT/SE2010/050659, filed on Jun. 11, 2010, and which claims the benefit of priority based on Swedish patent application No. SE 0950508-2, filed Jun. 30, 2009. The contents of each of PCT/SE2010/050659 and SE 0950508-2 are expressly incorporated herein by reference in their entirety.

### TECHNICAL FIELD

The disclosure relates to a wiping material system comprising a plurality of dispensers of different shapes and/or sizes. The disclosure further relates to a method for improving safety at a workplace and a method of disguising colour-mismatch of components of a range of object-wiping material dispensers of different sizes.

### BACKGROUND OF THE INVENTION

The manufacturing, HoReCa (Hotel, restaurant, catering), healthcare and servicing/repair industries are highly reliant on wiping material such as paper and nonwoven for preparing and cleaning surfaces. These surfaces may be on components which are manufactured or repaired, equipment which is used for manufacturing or repair, surfaces on which foodstuff is prepared or floors upon which equipment stands. The wiping material is normally housed in a suitable dispenser at a location which is convenient for the particular surface.

Generally, a particular type of wiping material is associated with each specific wiping application. For example, for preparing a highly polished surface it is common to utilize a soft low-linting cloth, whilst for e.g. an oil spillage it is common to use a material with good absorption properties. Since a particular type of wiping material may be associated with a specific wiping application and each type of wiping material has dedicated properties, each type of wiping material format, e.g. roll, cut wipers, etc., normally has a dispenser which is specially adapted to that type of wiping material format, including the volume of wiping material needed.

In a workshop in which several different processing activities take place it is common to provide the types of wiping material which may be called upon during the processing in the vicinity of the equipment which carries out the processing activities. The operator of a particular piece of equipment is therefore familiar with the appearance and location of the dispensers containing the wiping materials which are deemed useful or necessary for the wiping applications which are associated with that equipment. However, should the operator have to operate a piece of equipment with which he/she is unfamiliar, then it may not be immediately apparent where the necessary wiping material is located. Whilst, at best, this may be regarded as somewhat inconvenient, in the case of, for example, an oil spill, it is imperative that cleaning-up action is initiated as quickly as possible.

When manufacturing articles from a plurality of coloured components, it is not uncommon that the colour is imparted at a workstation dedicated to that component. Thus, for components made of plastics material, for example, each component is produced in a dedicated mould. Particularly when switching to a new batch of plastics granules, problems with colour mismatching may occur. As such, when the article is assembled, components which are intended to have the same colour may in fact be perceived as having a slightly different colour.

It is therefore an object of the present invention to provide a system and method for improving the safety of workers in a workshop. It is a further object of the present invention to provide a system and method in which colour mismatch of components making up a range of articles can be effectively disguised.

### SUMMARY OF THE INVENTION

One or more of the above objects is achieved in accordance with the present invention by a wiping material system comprising a plurality of dispensers of different sizes, the dispensers comprising at least a first and a second component, with the first and second components being visible to a user. The first component is of a first colour and the second component is of a second colour, with the first and second colours being distinct from each other. The colour of the first component and the colour of the second component are identical for all dispensers of the plurality of dispensers.

By providing a plurality of dispensers of different sizes with the dispensers including at least two components of the same distinctly different colours, a worker at a workplace in which different such dispensers are located can intuitively recognise from the two-colour combination that the object is a dispenser, even though the size and shape of the different dispensers may differ considerably.

In this respect, at least insofar as the present invention is concerned, two colours which are distinct from each other are colours which are metamers of different pure spectral colours, or a metamer of a pure spectral colour and a non-spectral colour, or two contrasting non-spectral colours.

According to example embodiments the first, the second and one or more additional components of the dispensers are arranged such that at least some of the first, the second and any one or more additional components do not lie adjacent a component of the same colour. In this manner, components of notionally the same colour are separated from each other so that colour mismatch is effectively disguised.

The present invention also relates to a method for improving safety at a workplace, the method comprising the steps of:

providing a plurality of dispensers of different shapes and/or sizes, the dispensers each comprising at least a first and a second component, the first and second components being visible to a user, the first component being of a first colour and the second component being of a second colour, the first and second colours being distinct from each other, wherein the colour of the first component and the colour of the second component are identical for all dispensers of the plurality of dispensers, and

installing the plurality of dispensers at the workplace.

The workplace may be selected from the group consisting of commercial catering establishments, hotels, healthcare facilities, manufacturing industry, process industry and service/repair facilities.

Since the plurality of dispensers comprise components of at least two distinct colours, it is further assured that, irrespective of the colour of the background, e.g. wall, where the dispenser is located, at least one colour, due to its distinctness, will always be readily visible, even if the other colour exhibits poor contrast with the background.

The present invention also provides for a method of disguising colour-mismatch of components of a range of object-wiping material dispensers of different shapes and/or sizes, the dispensers each comprising at least a first and a second component made of plastics material, the first and second components being visible to a user. The method comprises the steps of

selecting a colour for the first component which is distinct from the colour of the second component, the colour of the first component and the colour of the second component being identical for all dispensers of the plurality of dispensers;

providing the first and second components, and

assembling the components such that the first, second and one or more additional components are arranged such that at least some of the first, the second and any one or more additional components do not lie adjacent a component of the same colour.

Further example embodiments are detailed in the dependent claims.

### BRIEF DESCRIPTION OF THE DRAWINGS

The invention will be described in the following by way of example only and with reference to the attached drawings in which:

FIG. 1 is a schematic perspective view of a first dispenser employing the principles of the present invention;

FIG. 2 is a schematic perspective view of a second dispenser employing the principles of the present invention;

FIG. 3 is a schematic perspective view of a third dispenser employing the principles of the present invention, and

FIG. 4 is a schematic perspective view of a fourth dispenser employing the principles of the present invention.

### DETAILED DESCRIPTION OF PREFERRED EMBODIMENTS

Before describing the attached drawings, it may be useful to familiarize oneself with aspects of the science of colour, i.e. chromatics. As is explained on Wikipedia.org, chromatics includes the perception of colour by the human being, as well as the physics of electromagnetic radiation in the visible range. Electomagnetic radiation is characterized by its wavelength and its intensity. Most light sources emit light at many different wavelengths. A colour may be defined as a class of spectra that give rise to the same colour sensation. In each class the members are called metamers of the colour in question.

The colours of the rainbow include all those colours that can be produced by visible light of a single wavelength only. These colours are known as pure spectral colours and the relevant colours are commonly identified as red, orange, yellow, green, blue and violet. The table below shows the approximate wavelengths (in nanometers) for various pure spectral colours.

| Colour | Wavelength interval |
|---|---|
| Red | ~700-630 nm |
| Orange | ~630-590 nm |
| Yellow | ~590-560 nm |
| Green | ~560-490 nm |
| Blue | ~490-450 nm |
| Violet | ~450-400 nm |

Examples of non-spectral colours are the achromatic colours (black, grey and white) and colours such as pink, tan and magenta.

Ignoring human perception, objects can be said to have the colour of the light leaving their surfaces.

In the drawings, reference number 10 denotes dispensers making up a wiping material system, with each of the dispensers of the system being of a different shape and/or size. Each of the dispensers 10 comprises at least a first component 12 and a second component 14. Typically, these components may be made of a plastics material such as ABS, or a composite material. For high-end applications it is also possible that the dispensers be fabricated from metal. Irrespective of the choice of material, the first and second components 12, 14 are visible to a user when using the dispensers for their intended purpose, i.e. when a user is to remove wiping material from the dispensers. Being visible to a user is meant to include not only components that are opaque or solid, but also components that are semi-transparent or smoked. The first component 12 is of a first colour and the second component 14 is of a second colour, with the first and second colours being distinct from each other. The colour of the first component and the colour of the second component are identical for all dispensers 10 of the plurality of dispensers.

For ease of understanding, in each of the drawings the colour of the first component 12 is depicted as shaded, whilst the colour of the second component remains unshaded.

In example embodiments of the invention, one of said first and second components is of an achromatic colour, such as black or grey.

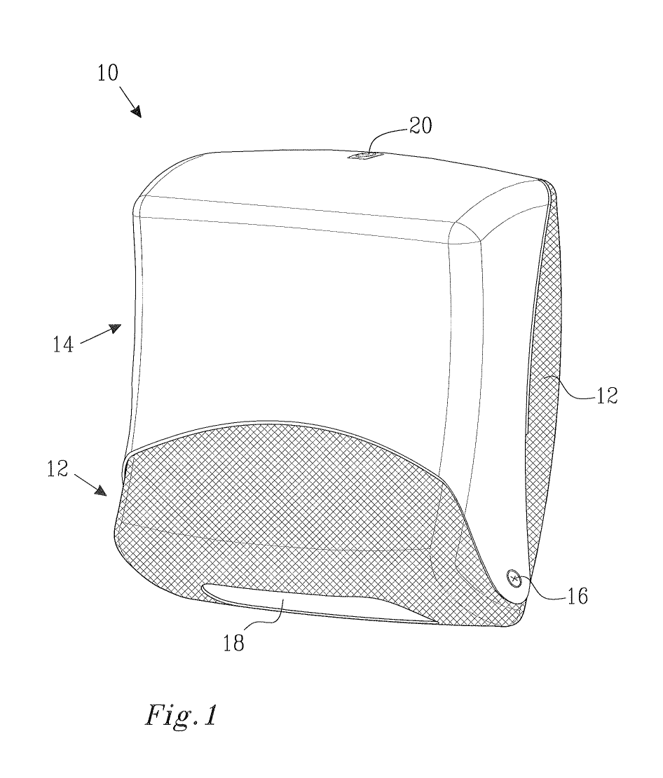

In example embodiments of the invention as exemplified in FIGS. 1 to 3, the first component 12 is a base unit adapted to be affixed to a wall and the second component 14 is an access lid of the dispenser. Thus, in FIG. 1, the access lid is arranged to pivot about a substantially horizontally disposed pivot axis 16 arranged on the base unit. The dispenser of FIG. 1 is provided in a known manner in its base unit with a dispensing opening, the location of which is indicated by arrow 18. At a location opposite to the dispensing opening 18, the dispenser may be provided with a lock arrangement 20 to prevent unauthorised access to contents of the dispenser, i.e. wiping material. In the shown embodiment, the lock arrangement is carried on the access lid, though it is to be understood that in other embodiments the lock arrangement may be carried by the base unit. The dispenser of the type illustrated in FIG. 1 is suitable for dispensing wiping material in the form of individual arcs of e.g. paper or nonwoven lying horisontally one on top of the other, i.e. in a stack

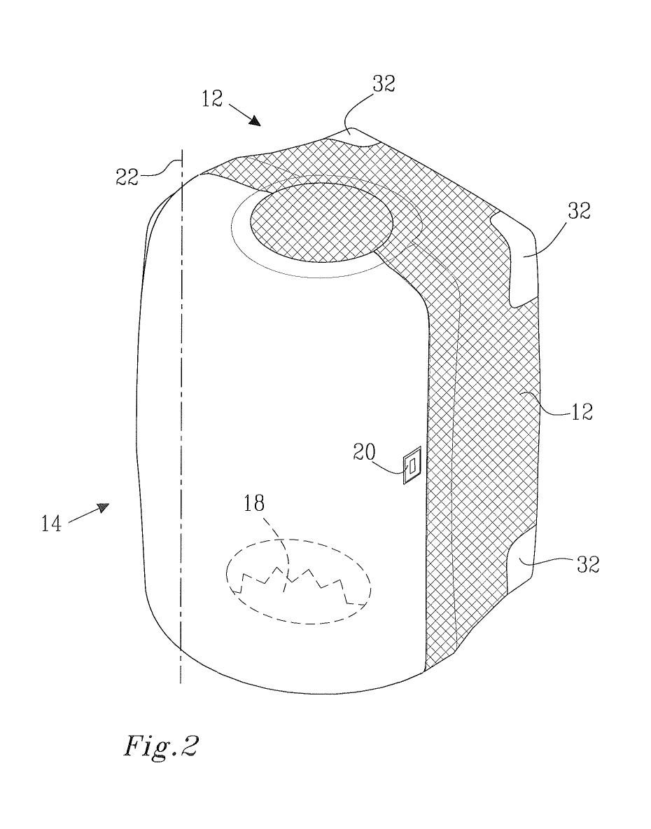

In FIG. 2, the access lid (corresponding to the second component 14) is arranged to pivot about a substantially vertical axis 22 disposed adjacent one side member of the base unit (corresponding to the first component 12). Again, a lock arrangement 20 may be arranged on either the access lid (as illustrated) or on the base unit. The dispenser of FIG. 2 is provided with a dispensing opening in its base unit, the location of which is indicated by arrow 18. The dispenser is intended to be used with rolls of so-called centerfeed paper, i.e. a cylinder of paper arranged with its longitudinal axis in the vertical direction, with the central-most layers of paper being removed from the roll via the dispensing opening. Typically, the dispensing opening is provided with serrations so that a desired amount of paper can be torn off from the roll.

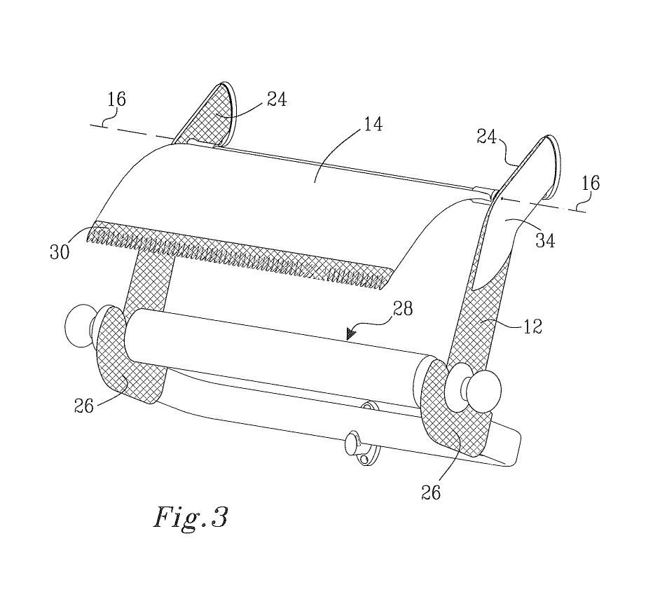

The dispenser illustrated in FIG. 3 is adapted to be affixed to a wall by means of two support arms 24, one of which constituting the first component 12. The support arms 24 are provided with hook-shaped lower ends 26 for supporting an essentially horizontally disposed spindle 28. The spindle is intended to carry a cylindrical roll of wiping material, such as paper or nonwoven. Extending substantially circumferentially around the roll of wiping material is an access lid (corresponding to the second component 14). The access lid is arranged to pivot about a substantially horizontally disposed pivot axis 16 arranged on the support arms 24. In contrast to centerfeed paper rolls, the wiping material which is carried by the spindle 28 is removed with the outermost layer first. At its end opposite to the pivot axis 16, the access lid is provided with a serration arrangement 30, allowing a desired quantity of wiping material to be torn off from the roll.

In accordance with example embodiments, the first and second components 12, 14 constitute at least 80% of the visible surface(s) of the dispenser. Indeed, in the dispenser illustrated in FIG. 1 the base unit and the access lid make up essentially 100% of the visible surface(s).

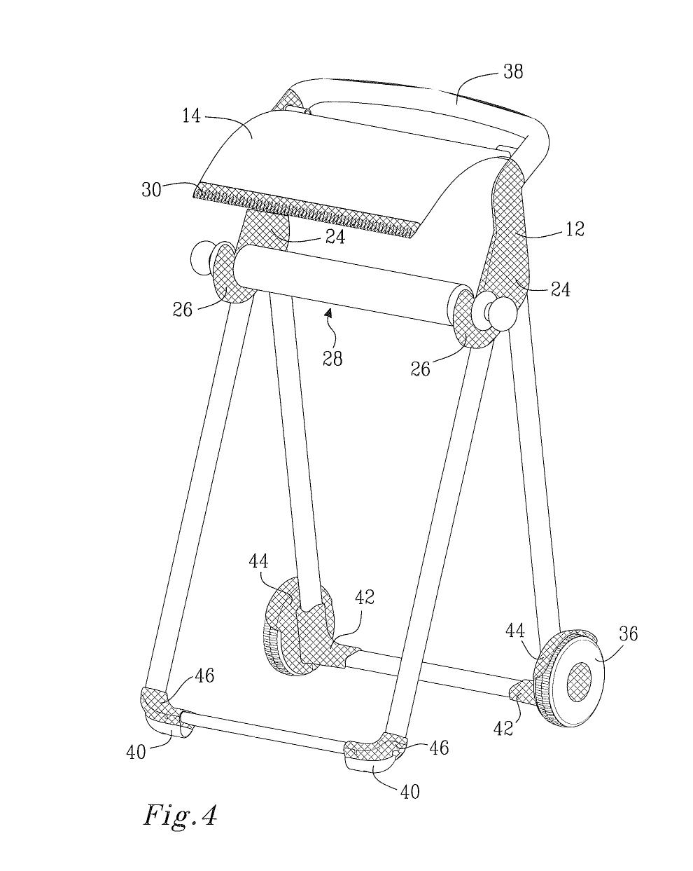

In contrast to the dispensers illustrated in FIGS. 1 to 3, the dispenser of FIG. 4 is intended to stand on a floor. In similarity to the FIG. 3 embodiment, the dispenser of FIG. 4 is intended to dispense wiping material from a roll carried by a substantially horizontally mounted spindle 28, the spindle being supported by hook-shaped lower ends 26 of support arms 24. As with the FIG. 3 embodiment, one of the support arms 24 is constituted by the first component 12 and an access lid pivotally mounted in the same manner as in FIG. 3 is constituted by the second component 14.

As well as being provided with a base unit and an access lid, the dispenser of FIG. 2 also has additional components 32 which are visible to a user. In FIG. 2, these additional components constitute corner pieces affixed to the base unit, i.e. affixed to the first component 12. These additional components may suitably be manufactured from a plastics material or other suitable materials such as rubber. The dispensers of FIGS. 3 and 4 are also provided with additional components such as support arm side pieces 34 in FIG. 3 and wheels 36, a handle 38 and feet 40 in FIG. 4. In accordance with example embodiments, at least one of these additional components 32, 34, 36, 38, 40 has the same colour as the second component 14, i.e. the same colour as the access lid.

In example embodiments, the second component 14 may be of an achromatic colour, such as black or grey. Thus, by way of example, in FIG. 2 the access lid and at least one of the corner pieces are of an achromatic colour.

In example embodiments, at least one of the additional components has the same colour as the first component 12. In such cases, the serration arrangement 30 in FIGS. 3 and 4 may constitute such an additional component. Furthermore, in FIG. 4, the wheels 36 may be carried by corner units 42 and protected by shrouds 44, at least one of which may be deemed to be an additional component having the same colour as the first component 12. In addition, the feet 40 may be carried by feet support 46, also of the same colour as the first component 12.

To provide an easily identifiable appearance, in example embodiments the first component may be of a colour having a wavelength from 450 nm to 670 nm. For example, therefore, the first component may be red and the second component may be a dark grey or black.

A further distinct combination is arrived at by having the first component be white and the second component be turquoise. In such embodiments one or more of the additional components may for example be black.

In example embodiments the first, the second and one or more additional components of the dispensers are arranged such that at least some of the first, the second and any one or more additional components do not lie adjacent a component of the same colour. Thus, in the FIG. 2 embodiment the additional components in the form of one or more of the corner pieces 32 are separated from the access lid by the first component 12 which is of a different colour to the access lid and one or more of the corner pieces. In FIGS. 3 and 4, the serration arrangements 30 are separated from other components of the same colour by the access lid 14.

As mentioned above, the dispensers illustrated in the drawings are suitable for dispensing wiping material which is either stacked, rolled on a centerfeed roll or rolled on a circumferential feed roll. Typically, the wiping material will usually either be made of paper based on cellulose fibres (either virgin or recycled) or made of hydroentangled nonwoven material. In the latter case, the nonwoven material may be composed of a mixture of staple fibres, filaments and pulp fibres. Wiping material refills supplied by the present applicant under the trade name Tork W4 Top Pak may be used together with the dispenser illustrated in FIG. 1. Refills in three different sizes are available for the dispenser of FIG. 2, depending on its dimensions. These refills are available under the trade names M1 Mini Centerfeed Roll, M2 Centerfeed Roll and W2 Combi Roll. Finally, refills for the dispensers illustrated in FIGS. 3 and 4 are available under the trade name W1 Wall Stand/Floor Stand.

The invention has been described above by way of example only and the skilled person will appreciate that various modifications may be made within the scope of the invention as defined by the appended claims. For example, the maximum number of colours displayed by the dispensers may be restricted to three or four.

1. A wiping material system comprising a plurality of dispensers of different shapes and/or sizes, the dispensers each comprising at least a first and a second component, said first and second components being visible to a user,
wherein said first component is of a first colour and said second component is of a second colour, said first and second colours being distinct from each other, wherein the colour of said first component and the colour of said second component are identical for all dispensers of said plurality of dispensers.

2. The wiping material system of claim 1, wherein one of said first and second components is of an achromatic colour.

3. The wiping material system as claimed in claim 1, wherein said first component is a base unit adapted to be affixed to a wall and said second component is an access lid.

4. The wiping material system as claimed in claim 3, wherein said first and second components constitute at least 80% of the visible surface of the dispenser.

5. The wiping material system as claimed in claim 1, wherein each dispenser further comprises additional components which are visible to a user, at least one of said additional components having the same colour as said second component.

6. The wiping material system as claimed in claim 2, wherein said second component is of an achromatic colour.

7. The wiping material system as claimed in claim 5, wherein at least one of said additional components has the same colour as said first component.

8. The wiping material system as claimed in claim 1, wherein said first component is of a colour having a wavelength from 450 nm to 670 nm.

9. The wiping material system as claimed in claim 1, wherein each dispenser further comprises one or more additional components which are visible to a user,
wherein said first, said second and one or more additional components of the dispensers are arranged such that at least some of the first, the second and any one or more additional components do not lie adjacent a component of the same colour.

10. A method for improving safety at a workplace, the method comprising the steps of:
providing a plurality of dispensers of different shapes and/or sizes, the dispensers each comprising at least a first and a second component, said first and second components being visible to a user, said first component being of a first colour and said second component being of a second colour, said first and second colours being distinct from each other, wherein the colour of said first component and the colour of said second component are identical for all dispensers of said plurality of dispensers, and
installing said plurality of dispensers at said workplace.

11. The method as claimed in claim 10, wherein said workplace is selected from the group consisting of commercial catering establishments, hotels, healthcare facilities, manufacturing industry, process industry and service/repair facilities.

12. A method of disguising colour-mismatch of components of a range of object-wiping material dispensers of different shapes and/or sizes, the dispensers each comprising at least a first a second component, and one or more additional components, said first, second, and one or more additional components being visible to a user, the method comprising the steps of:
selecting a colour for said first component which is distinct from the colour of said second component, the colour of said first component and the colour of said second component being identical for all dispensers of said plurality of dispensers, and
assembling said components such that said first, said second and one or more additional components are arranged such that at least some of the first, the second and any one or more additional components do not lie adjacent a component of the same colour.

13. The wiping material system as claimed in claim 1, wherein said first component is a base unit adapted to be affixed to a wall and said second component is an access lid,
wherein said first and second components constitute at least 80% of the visible surface of the dispenser,
wherein each dispenser further comprises one or more additional components which are visible to a user,
wherein said first, said second and one or more additional components of the dispensers are arranged such that the first, the second and the one or more additional components do not lie adjacent a component of the same colour.

14. The method as claimed in claim 10, wherein said first component is a base unit adapted to be affixed to a wall and said second component is an access lid,
wherein said first and second components constitute at least 80% of the visible surface of the dispenser,
wherein each dispenser further comprises one or more additional components which are visible to a user,
wherein said first, said second and one or more additional components of the dispensers are arranged such that the first, the second and the one or more additional components do not lie adjacent a component of the same colour.

15. The method as claimed in claim 12, wherein said first component is a base unit adapted to be affixed to a wall and said second component is an access lid,
wherein said first and second components constitute at least 80% of the visible surface of the dispenser.
